(19) United States
(12) Patent Application Publication
(10) Pub. No.: US 2009/0171696 A1
(43) Pub. Date: Jul. 2, 2009

(54) SYSTEM AND METHOD FOR PATIENT PORTAL WITH CLINICAL DECISION INTELLIGENCE

(76) Inventors: David Joseph Allard, Boynton Beach, FL (US); James R. Kraemer, Santa Fe, NM (US)

Correspondence Address: DUKE W. YEE, YEE AND ASSOCIATES, P.C., P.O. BOX 802333, DALLAS, TX, 75380, US

(21) Appl. No.: 11/968,239

(22) Filed: Jan. 2, 2008

(51) Int. Cl. G06Q 10/00

(52) U.S. Cl. 705/3

(57) ABSTRACT

A computer-implemented method for transmitting a scheduled appointment to a patient. Input is received, wherein the input comprises at least one of current data provided by the patient, prior data provided by the patient prior to the current data, and known medical history of the patient. A possible condition of the patient is diagnosed based on the input. The appointment is scheduled for the patient based on the diagnosis. The scheduled appointment is transmitted to the patient.

### BACKGROUND OF THE INVENTION

1. Field of the Invention

The present invention relates generally to an improved method, computer usable program product, and data processing system. More specifically, the present invention relates to a system and method for performing clinical decision analysis.

2. Description of the Related Art

In the area of health care, electronic systems have been proposed to improve patient outcomes and reduce the cost of health care. One type of electronic health care systems can be referred to as Electronic Health Record (EHR) Systems (EHRS). Another type of electronic health care systems produce reminders or alerts to physicians in the course of the physician entering observations and/or orders. This type of health care system is commonly referred to as Clinical Decision Intelligence (CDI). Both of these health care systems have the potential to assist physicians in the treatment of patients.

One of the major goals of clinical decision intelligence systems and electronic health record systems is to reduce medical errors. According to the Institute of Medicine, medical errors cause 100,000 deaths each year in the United States alone. Although application of clinical decision intelligence has a potential of saving tens of thousands of lives each year, these health care systems tend to slow down the physician. On this and possibly other bases, some physicians oppose clinical decision intelligence.

Currently, patient portal systems are available that allow patients to schedule and change doctor appointments and to view medical test results on line. Some patient portals have been proposed that might suggest changes to medication dosage based on patient data. For example, a recommendation can be made as to adjustment of insulin dosage based on patient entered blood glucose levels.

However, current health care systems lack important abilities, such as prioritized scheduling of patients, emergency alerts, pre-care advice, patient-assisted diagnosis, and other capabilities. Such capabilities could further reduce medical errors and further improve the quality of health care to patients.

### SUMMARY OF THE INVENTION

The illustrative embodiments provide for a computer-implemented method, computer program product, and data processing system for transmitting a scheduled appointment to a patient. Input is received, wherein the input comprises at least one of current data provided by the patient, prior data provided by the patient prior to the current data, and known medical history of the patient. One or more possible conditions of the patient are diagnosed based on the input. The appointment is prioritized and scheduled for the patient based on the diagnosis. The scheduled appointment is transmitted to the patient.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems, in which illustrative embodiments may be implemented;

FIG. 2 is a block diagram of a data processing system, in which illustrative embodiments may be implemented;

FIG. 3 is a block diagram of a health care electronic system, in accordance with an illustrative embodiment;

FIG. 4 is a flowchart of operation of a health care electronic system, in accordance with an illustrative embodiment;

FIG. 5 is a flowchart of complaint analysis in a health care electronic system, in accordance with an illustrative embodiment;

FIG. 6 is a flowchart of patient medical history collection in a health care electronic system, in accordance with an illustrative embodiment; and

FIG. 7 is a flowchart of operation of a health care electronic system, in accordance with an illustrative embodiment.

### DETAILED DESCRIPTION OF THE PREFERRED EMBODIMENT

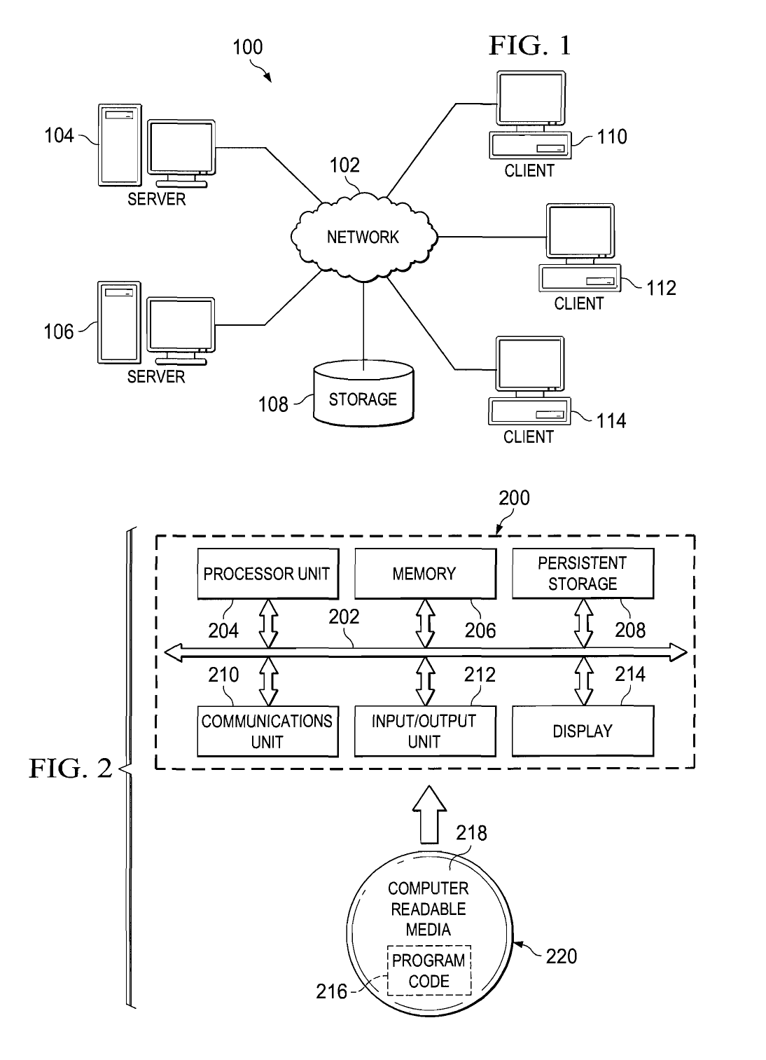

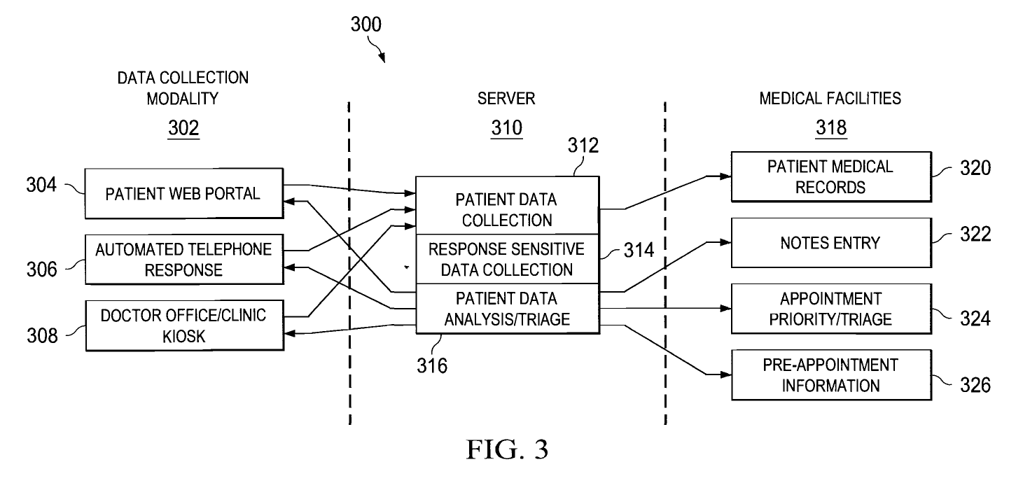

FIGS. 1-2 are exemplary diagrams of data processing environments in which illustrative embodiments may be implemented. FIGS. 1-2 are only exemplary and are not intended to assert or imply any limitation with regard to the environments in which different embodiments may be implemented. Many modifications to the depicted environments may be made.

FIG. 1 is a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, and may also provide executable software, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

FIG. 2 is a block diagram of a data processing system in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a set of one or more multi-processor cores, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as, program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive or a flash memory that is connected to data processing system 200. The tangible form of computer readable media 218 is also referred to as computer recordable storage media.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

For example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

The illustrative embodiments provide for a computer-implemented method, computer program product, and data processing system for transmitting a scheduled appointment to a patient. Input is received, wherein the input is comprised of at least one of the following: current data provided by the patient, prior data provided by the patient prior to the current data, and known medical history of the patient. One or more possible conditions of the patient is diagnosed based on the input. The appointment is scheduled for the patient based on the set of diagnosis. The scheduled appointment is transmitted to the patient. Note that as used herein the term “patient” can include the patient, the patient's representative, or some other proxy for the patient.

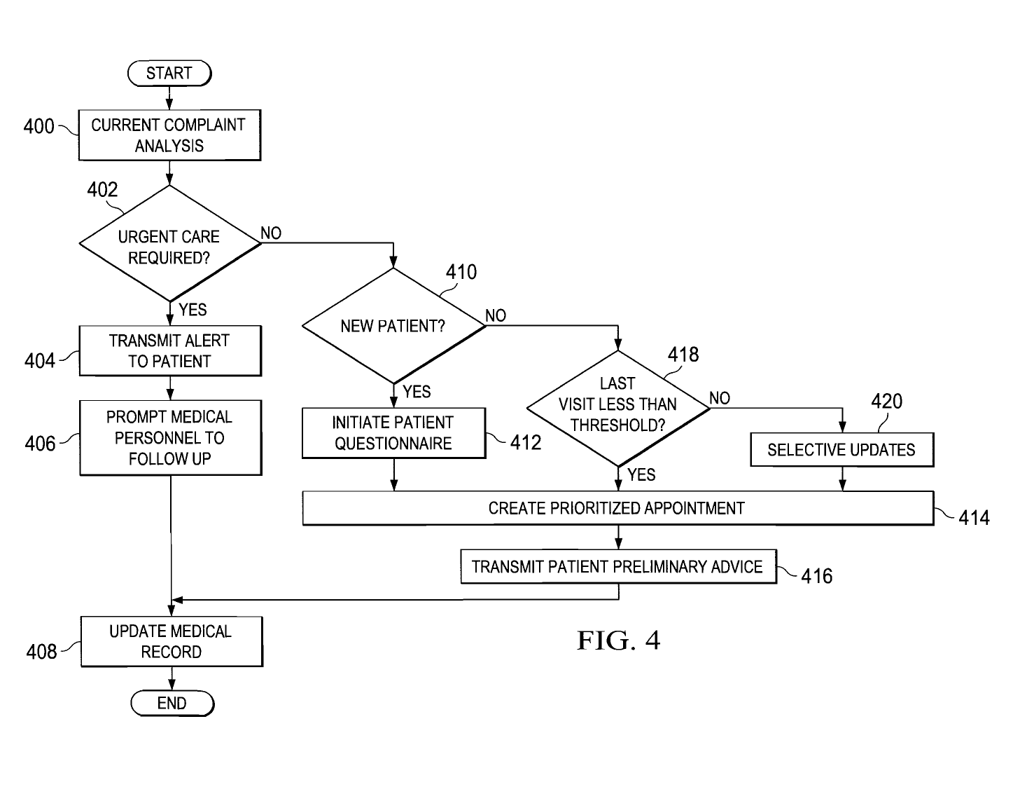

FIG. 3 is a block diagram of a health care electronic system, in accordance with an illustrative embodiment. Health care electronic system 300 can be implemented in one or more data processing system, such as data processing system 200 shown in FIG. 2. Various communication aspects of health care electronic system 300 can be implemented using a network, such as network 100 shown in FIG. 1.

In the illustrative example shown in FIG. 3, data collection modality 302 is used to collect and store a variety of information about a patient. Data collection modality 302 can collect and store information from and about patients in many different ways. Three non-limiting examples of data collection modality 302 include patient web portal 304, automated telephone response 306, and kiosk 308. Patient web portal 304 can be a means by which a user can use a browser to log onto a data collection site or data collection server or software. Automated telephone response 306 can be implemented by a user using phone buttons or voice commands to respond to questions provided to the user over a telephone or wireless connection. Kiosk 308 can be a kiosk, user workstation, a handheld device, or tablet laptop computer. Any of these devices could be located at a hospital, doctor's office, or other medical facility. Other methods of collecting patient data exist, such as but not limited to computer-generated questionnaires.

Data collection modality 302 interacts with server 310. Server 310 generates intelligent questions to the patient via data collection modality 302. Note that as-used herein the term “patient” can include the patient, the patient's representative, or some other proxy for the patient. Server 310 can use rules-based analysis, heuristic analysis, neural network analysis, or other forms of analysis to generate questions for the patient to answer based on data collected from data collection modality 302. Server 310 can also generate questions for the patient to answer based on answers to prior questions, medical history, or other data. Exactly which questions are asked of the patient and in what order the questions are posed varies depending on the patient's answers to questions, the patient's medical history, the seriousness of developing diagnoses, and possibly other information. Server 310 can include one or more data processing systems, possibly connected over a network and possibly including geographically separated data processing systems.

Thus, server 310 provides three primary services, including patient data collection 312, response sensitive data collection 314, and patient data analysis and triage 316. Patient data collection 312 collects data from the patient and causes the data to be stored as part of the patient's medical record.

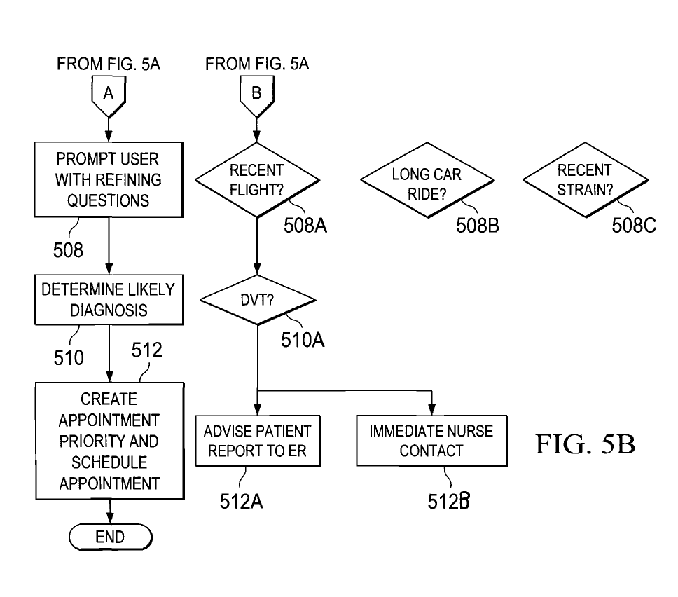

Response sensitive data collection 314 provides rules or other logic for generating questions to collect data based on the responses to previous questions. An example of a method of performing response sensitive data collection is shown in FIG. 5.

Patient data analysis and triage 316 establishes a preliminary diagnosis or set of probable diagnosis based on the patient's response to the questions presented to the patient. An example of patient data analysis and triage 316 is also shown in FIG. 5. Based on the generated preliminary diagnosis, an appointment is generated for the patient. The appointment is prioritized relative to other appointments based on the type of diagnosis generated. In extreme cases, where a possible medical emergency is indicated, the patient is prompted to seek immediate emergency care. Server 310 can take the additional step of prompting medical personnel, such as but not limited to nurses, doctors, ambulance services, other medical personnel, or even police officers to contact the patient and/or to render aid to the patient.

Server 310 also interacts with medical facilities 318, which could include but is not limited to a physician's office, a clinic, an urgent care facility, a hospital, a laboratory, or other medical facilities. Medical facilities 318 also include patient medical records 320, notes entry 322, appointment priority and triage 324, and patient pre-appointment information 326. Patient medical records 320 provides a database and/or physical storage for storing medical records. Patient medical records 320 can be an established electronic health record system.

Notes entry 322 assists a physician by entering notes of value to a physician. Notes entry can include probable diagnosis information, follow-up questions, recommendations, or other information, which can be updated and appended to by a physician or other health care provider.

Appointment priority and triage 324 receives the prioritized appointment generated by patient analysis and triage service 316 on server 310. Appointment priority and triage 324 keeps track of patient appointments and can assist in assigning appointment priorities.

Patient pre-appointment information 326 can be used to generate pre-appointment advice to the patient. The pre-appointment advice can include instructions to the patient to take one or more actions to assist the patient with the patient's condition. The pre-appointment advice can be to take one or more actions to increase the speed and/or effectiveness of serving the patient once the patient arrives at the medical facility. In illustrative example, the pre-appointment advice can include taking medication, not eating overnight or in the morning, omitting certain foods from the patients diet that could confound laboratory tests, drinking or not drinking fluids, resting, implementing a medical procedure, and combinations thereof.

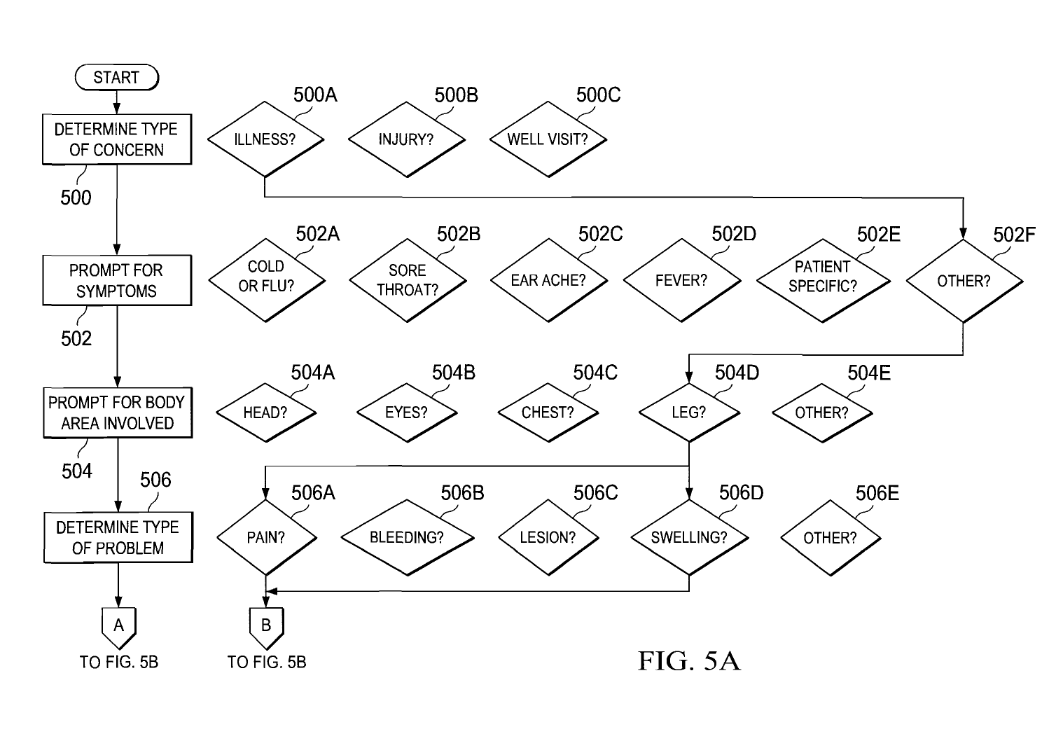

FIG. 4 is a flowchart of operation of a health care electronic system, in accordance with an illustrative embodiment. The process shown in FIG. 4 can be implemented in a data processing system, such as data processing system 200 shown in FIG. 2. The process shown in FIG. 4 can be implemented via communications, which can be wired, wireless, or implemented over a network of data processing systems. The process shown in FIG. 4 can be implemented using server 310 shown in FIG. 3.

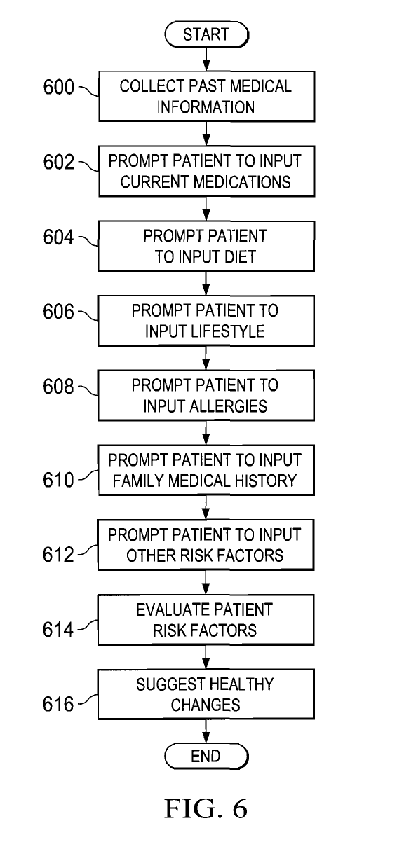

The process begins as the server performs a current complaint analysis (step 400). Current complaint analysis is performed via intelligently presenting a series of questions to a patient, wherein the series of questions depends on answers to prior questions in the serious of questions and/or on the patient's medical history. An example of complaint analysis is shown in FIG. 5. Complaint analysis is also performed by collecting medical information from the patient. An example of collecting medical information from a patient is shown in FIG. 6.

After performing current complaint analysis at step 400, the server then determines whether urgent care is required based on the diagnosis generated at step 400 (step 402). If urgent care is required, the server then transmits an alert to the patient (step 404). The alert can be any communication advising the patient to seek emergency care or to take some action on an emergency basis, including possibly taking medication or implementing some medical procedure. Subsequently or at the same time, the server prompts at least one medical personnel to contact the patient (step 406) and/or to render aid to the patient. The server then updates the medical record (step 408), and the process terminates.

Returning to step 402, if urgent care is not required or advised, then the server determines whether the patient is a new patient (step 410). If the patient is a new patient, the server then initiates a patient questionnaire (step 412). The patient questionnaire can be more detailed than the questionnaire presented as a part of performing a current complaint analysis. For example, in-depth medical history can be solicited from the patient. An example of performing an initial patient questionnaire is presented in FIG. 6.

After performing the initial patient questionnaire, the server then creates a prioritized appointment for the patient with medical personnel (step 414). The appointment is prioritized relative to other patients and the conditions of those other patients relative to the patient's condition. Medical personnel can be selected by the user, selected by the server, or selected by a combination of user choice and automatic selection.

In any case, the server then may transmit to the patient preliminary advice (step 416). Preliminary advice is similar to the pre-appointment advice described with respect to FIG. 3. Thus, preliminary advice can include instructions to the patient to take one or more actions to assist the patient with the patient's condition or later diagnosis. The preliminary advice can be to take one or more actions to increase the speed and/or effectiveness of serving the patient once the patient arrives at the medical facility. In illustrative example, the preliminary advice can include taking medication, resting, implementing a medical procedure, and combinations thereof.

After possibly presenting the patient with preliminary advice, the server updates the patient's medical record accordingly at step 408. The process terminates thereafter.

Returning to step 410, if the patient is not a new patient, then the server determines whether the patient's last visit is less than some threshold (step 418). The threshold can be a pre-determined time, such as one year, or can be dynamically generated based on the patient's medical history and/or information generated during the patient questionnaire or current analysis. If the patient's last visit occurred within a time less than the threshold, then the process proceeds to step 414 for the generation of prioritized appointments. In an illustrative example, the determination at step 418 leads to an additional patient questionnaire, and thereafter to the prioritized appointment based on answers to the additional patient questionnaire.

However, if the determination at step 418 is that the date of the patient's last visit is longer than the threshold, the server then implements selective updates to patient data (step 420). Selective updates to patient data can include presenting a patient with an updated questionnaire, which can be a dynamic questionnaire as described with respect to FIG. 3. Selective updates can also include accessing existing medical records to determine if those medical records have been updated in the intervening time since the last patient visit. If desired or indicated, the server can update the patient's information with the existing medical records. The server can then use the gathered information to generate prioritized appointments at step 414 and possibly present the patient with preliminary advice at step 416. Based on the patient medical history, the system might also advise the patient of and offer scheduling assistance with preventive care visits, such those associated with but not limited to gynecological exams, mammograms, colonoscopies, or any other medical procedure. The process terminates thereafter.

FIG. 5 is a flowchart of complaint analysis in a health care electronic system, in accordance with an illustrative embodiment. The process shown in FIG. 5 can be implemented in a data processing system, such as data processing system 200 shown in FIG. 2. The process shown in FIG. 5 can be implemented via communications, which can be wired, wireless, or implemented over a network of data processing systems. The process shown in FIG. 5 can be implemented using server 310 shown in FIG. 3. The process shown in FIG. 5 can be implemented as part of current complaint analysis, step 400 of FIG. 4.

The process begins as the server determines the type of concern the patient has (step 500). For example, the server can prompt the patient for a determination whether the type of concern is an illness (500A), injury (500B), or well visit (500C). Other types of concern can be used. In this illustrative example, the type of concern is an illness (500A).

Because the type of concern is “illness” (500A), the server dynamically adjusts the following prompts in order to aid in diagnosing the type of illness. Thus, the server prompts the patient to input symptoms experience (step 502). For example, the server can prompt the patient to input whether the patient experiences cold or flu (502A), sore throat (502B), ear ache (502C), fever (502D), some patient-specific symptom (502E), or “other” (502F). Other symptoms or requests for input can be generated based on different symptoms, or request for input can be generated based on prior patient input or patient history, and sub-symptoms or sub-requests for input can be generated based on prior patient input or patient history. In this illustrative example, the patient selects “other” (502F).

The server then generates prompts for user input regarding what area of the body is affected (step 504) in order to further narrow the patient's condition. Thus, the server prompts the patient for input whether the patient's concern relates to the head (504A), eyes (504B), chest (504C), leg (504D), or other (504E). Other areas or requests for input can be generated based on different symptoms, or request for input can be generated based on prior patient input or patient history, and sub-body areas or sub-requests for input can be generated based en prior patient input or patient history. In this illustrative example, the patient selects “leg” (504D).

The server then attempts to determine the type of problem (step 506). Thus, the server prompts the patient to select one or more problems from pain (506A), bleeding (506B), lesion (506C), swelling (506D), and other (506E). Other problems or requests for input can be generated based, or request for input can be generated based on prior patient input or patient history, and sub-problems or sub-requests for input can be generated based on prior patient input or patient history. In this illustrative example, the patient selects both pain (506A) and swelling (506D).

Based on this input, the server continues to attempt to narrow the cause of the patient's concern. Thus, the server prompts the user with refining questions (step 508). Examples of refining questions based on pain and swelling in the leg include, in this example, whether the patient had a recent flight (508A), a long car ride (508B), or recent strain (508C). Other refining questions or requests for input can be generated, or request for input can be generated based on prior patient input or patient history, and sub-refining questions or sub-requests for input can be generated based on prior patient input or patient history. In this illustrative example, the user selects recent flight (508A).

Based on the total combination of all of the patient's input, and possibly also based on a further combination of the patient's medical history, the server determines a life threatening diagnosis is probable (step 510). In this illustrative example, a probable diagnosis of deep vein thrombosis (DVT) (510A) would take priority over other possible diagnosis with regard to the priority of care needed. Other likely diagnoses or requests for input can be generated, or request for input can be generated based on prior patient input or patient history, and sub-diagnoses or sub-requests for input can be generated based on prior patient input or patient history. In this case, further questions or prompts for user input may be generated.

The server then creates an appointment priority and schedules an appointment (step 512). In this illustrative embodiment, deep vein thrombosis is a potentially life threatening condition requiring immediate medical intervention. Thus, the server takes two steps simultaneously: To advise the patient to report to an emergency room (512A) and to prompt medical personnel to immediately contact the patient (512B). For example, the server can prompt a nurse on call to contact the patient and to advise the patient. The server could also prompt the patient to call an ambulance. In other illustrative embodiments, the server may recommend that the patient immediately take a medication or immediately perform some medical procedure. The server can also take other actions or prompt other individuals to take action with respect to the patient. For example, if the patient were suicidal, then the server may prompt someone to call the police or the server itself could cause the police to be notified of the patient's condition.

In still other illustrative embodiments, where a life threatening situation is not involved, the server may establish an appointment for the patient to see medical personnel. The server can prioritize the appointment according to the patient's need, as determined by the server, vis-à-vis all other patients already scheduled to see the same medical personnel. The server can also prompt the user to take some preliminary action in order to speed up or increase the effectiveness of the subsequent appointment.

FIG. 6 is a flowchart of patient medical history collection in a health care electronic system, in accordance with an illustrative embodiment. The process shown in FIG. 6 can be implemented in a data processing system, such as data processing system 200 shown in FIG. 2. The process shown in FIG. 6 can be implemented via communications, which can be wired, wireless, or implemented over a network of data processing systems. The process shown in FIG. 6 can be implemented using server 310 shown in FIG. 3. The process shown in FIG. 6 can take place as part of either step 400 or step 412 of FIG. 4, or both.

The process begins as the server collects past medical information relating to the patient (step 600). The server then prompts the patient to input current medications taken by the patient (step 602). Medications can include prescription medications, non-prescription languages, herbal supplements, diet supplements, alcohol, illegal substances and/or other substances.

The server then prompts the patient to input the patient's diet (step 604). The server can prompt the user by generating specific questions relating to patient diet. Similarly, the server prompts the patient to input the patient's lifestyles (step 606). Again, the server can prompt the user by generating specific questions relating to the patient's lifestyles. In an illustrative embodiment, the server identifies the lifestyle of the patient based on prior patient input. The server can also modify the generated lifestyle or the patient's input lifestyles based on subsequent questions.

The server also prompts the user to input patient allergies (step 608), family medical history (step 610), and other risk factors (612). Other risk factors can include smoking or other known behaviors or environmental factors that can increase the risk of health problems.

The server then evaluates the patient risk factors (step 614). Optionally, the server can suggest healthy changes (step 616). Suggestions for healthy changes can include specific changes to lifestyle, diet, or medications that would be considered healthy changes under accepted medical standards. For example, an overweight patient with a sedentary lifestyle can receive specific suggestions for exercise programs or diet specifically tailored to that patient. Patients that smoke can receive information related to specific quitting programs.

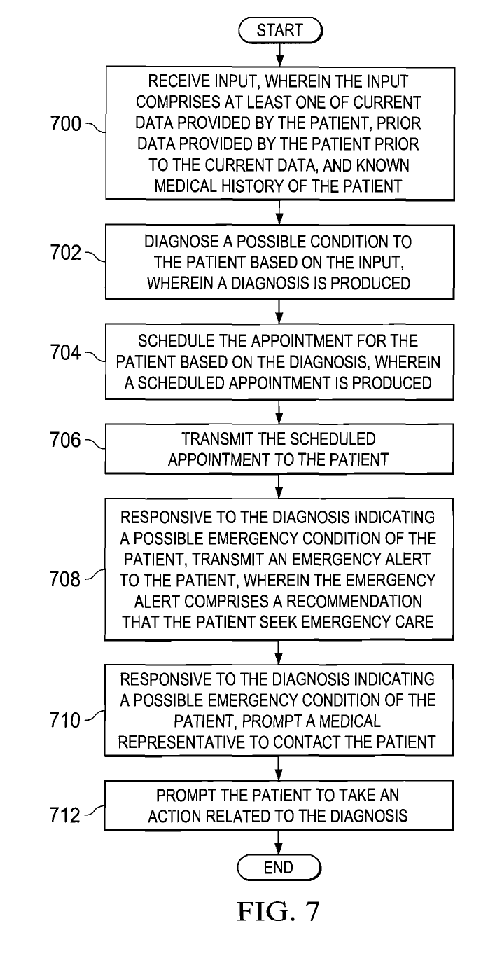

FIG. 7 is a flowchart of operation of a health care electronic system, in accordance with an illustrative embodiment. The process shown in FIG. 7 can be implemented in a data processing system, such as data processing system 200 shown in FIG. 2. The process shown in FIG. 7 can be implemented via communications, which can be wired, wireless, or implemented over a network of data processing systems. The process shown in FIG. 7 can be implemented using server 310 shown in FIG. 3.

The process begins as the server receives input, wherein the input comprises at least one of current data provided by the patient, prior data provided by the patient prior to the current data, and known medical history of the patient (step 700). Receiving input can include presenting a series of questions to the patient, wherein the series of questions comprise prompts for input. Subsequent questions in the series of questions change based on prior responses to prior questions in the series of questions. Similarly, subsequent questions in the series of questions change based on a medical history of the patient. Also similarly, subsequent questions in the series of questions change based on a combination of prior responses to prior questions in the series of questions and a medical history of the patient.

The processor then diagnoses a possible condition of the patient based on the input, wherein a diagnosis is produced (step 702). The processor schedules the appointment for the patient based on the diagnosis, wherein a scheduled appointment is produced (step 704). The appointment is prioritized relative to other patient appointments based on the diagnosis. The processor transmits the scheduled appointment to the patient (step 706).

Responsive to the diagnosis indicating a possible emergency condition of the patient, an emergency alert is transmitted to the patient, wherein the emergency alert comprises a recommendation that the patient seek emergency care (step 708). Responsive to the diagnosis indicating a possible emergency condition of the patient, a medical representative is prompted to contact the patient (step 710).

Whether or not the diagnosis indicates a possible emergency condition of the patient, the server prompts the patient to take an action related to the diagnosis (step 712). The action can include taking medication, resting, implementing a medical procedure, and combinations thereof.

The steps taken during the illustrative method of FIG. 7 can be performed using a variety of types of analysis. For example, diagnosing, scheduling, prompting the patient for input, and prompting the patient to take an action can be performed based on rules-based analysis, heuristic analysis, neural-network analysis, or other types of data analysis.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

Further, a computer storage medium may contain or store a computer readable program code such that when the computer readable program code is executed on a computer, the execution of this computer readable program code causes the computer to transmit another computer readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer-implemented method for transmitting a scheduled appointment to a patient comprising:
receiving input, wherein the input comprises at least one of current data provided by the patient, prior data provided by the patient prior to the current data, and known medical history of the patient;
diagnosing a possible condition of the patient based on the input, wherein a diagnosis is produced;
scheduling the appointment for the patient based on the diagnosis, wherein a scheduled appointment is produced; and
transmitting the scheduled appointment to the patient.

2. The computer-implemented method of claim 1 further comprising:
responsive to the diagnosis indicating a possible emergency condition of the patient, transmitting an emergency alert to the patient, wherein the emergency alert comprises a recommendation that the patient seek emergency care.

3. The computer-implemented method of claim 1 further comprising:
responsive to the diagnosis indicating a possible emergency condition of the patient, prompting a medical representative to contact the patient.

4. The computer-implemented method of claim 1 wherein receiving input comprises presenting a series of questions to the patient, wherein the series of questions comprise prompts for input.

5. The computer-implemented method of claim 4 wherein subsequent questions in the series of questions change based on prior responses to prior questions in the series of questions.

6. The computer-implemented method of claim 4 wherein subsequent questions in the series of questions change based on a medical history of the patient.

7. The computer-implemented method of claim 4 wherein subsequent questions in the series of questions change based on a combination of prior responses to prior questions in the series of questions and a medical history of the patient.

8. The computer-implemented method of claim 1 further comprising:
prompting the patient to take an action related to the diagnosis.

9. The computer-implemented method of claim 8 wherein the action is selected from the group consisting of taking medication, resting, implementing a medical procedure, and combinations thereof.

10. The computer-implemented method of claim 1 wherein the appointment is prioritized relative to other patient appointments based on the diagnosis.

11. The computer-implemented method of claim 1 wherein diagnosing is performed based on a type of analysis selected from the group consisting of rules-based analysis, heuristic analysis, and neural-network analysis.

12. The computer-implemented method of claim 1 wherein scheduling is performed based on a type of analysis selected from the group consisting of rules-based analysis, heuristic analysis, and neural-network analysis.

13. The computer-implemented method of claim 3 wherein prompting is performed based on a type of analysis selected from the group consisting of rules-based analysis, heuristic analysis, and neural-network analysis.

14. The computer-implemented method of claim 8 wherein prompting is performed based on a type of analysis selected from the group consisting of rules-based analysis, heuristic analysis, and neural-network analysis.

15. A computer program product comprising:
a computer usable medium having computer usable program code for transmitting a scheduled appointment to a patient, the computer program product including:
computer usable program code for receiving input, wherein the input comprises at least one of current data provided by the patient, prior data provided by the patient prior to the current data, and known medical history of the patient;
computer usable program code for diagnosing a possible condition of the patient based on the input, wherein a diagnosis is produced;
computer usable program code for scheduling the appointment for the patient based on the diagnosis, wherein a scheduled appointment is produced; and
computer usable program code for transmitting the scheduled appointment to the patient.

16. The computer program product of claim 15 further comprising:
computer usable program code for, responsive to the diagnosis indicating a possible emergency condition of the patient, transmitting an emergency alert to the patient, wherein the emergency alert comprises a recommendation that the patient seek emergency care; and
computer usable program code for, responsive to the diagnosis indicating a possible emergency condition of the patient, prompting a medical representative to contact the patient.

17. The computer program product of claim 15 further comprising:
computer usable program code for prompting to the patient to take an action related to the diagnosis.

18. A data processing system comprising:
a bus;
at least one processor coupled to the bus;
a computer usable medium coupled to the bus, wherein the computer usable medium contains a set of instructions for transmitting a scheduled appointment to a patient, wherein the at least one processor is adapted to carry out the set of instructions to:
receive input, wherein the input comprises at least one of current data provided by the patient, prior data provided by the patient prior to the current data, and known medical history of the patient;
diagnose a possible condition of the patient based on the input, wherein a diagnosis is produced;
schedule the appointment for the patient based on the diagnosis, wherein a scheduled appointment is produced; and
transmit the scheduled appointment to the patient.

19. The data processing system of claim 18 wherein the at least one processor is further adapted to carry out the set of instructions to:
responsive to the diagnosis indicating a possible emergency condition of the patient, transmit an emergency alert to the patient, wherein the emergency alert comprises a recommendation that the patient seek emergency care; and
responsive to the diagnosis indicating a possible emergency condition of the patient, prompt a medical representative to contact the patient.

20. The data processing system of claim 18 wherein the at least one processor is further adapted to carry out the set of instructions to:
prompt to the patient to take an action related to the diagnosis.
